(19) United States
(12) Patent Application Publication
(10) Pub. No.: US 2010/0174598 A1
(43) Pub. Date: Jul. 8, 2010

(54) METHODS, SYSTEMS AND COMPUTER READABLE MEDIA FOR REDEEMING AND DELIVERING ELECTRONIC LOYALTY REWARD CERTIFICATES USING A MOBILE DEVICE

(76) Inventors: Mohammad Khan, San Jose, CA (US); Pradeep Kumar, Fremont, CA (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/651,420

(22) Filed: Dec. 31, 2009

Related U.S. Application Data
(60) Provisional application No. 61/141,841, filed on Dec. 31, 2008.

(51) Int. Cl. G06Q 30/00; G06F 3/048; G06F 15/16; H04W 4/12

(52) U.S. Cl. 705/14.32; 715/760; 455/466

(57) ABSTRACT

Methods, systems, and computer readable media for redeeming and delivering electronic loyalty reward certificates using a mobile device are disclosed. In one example, the method includes utilizing a loyalty reward certificate selection device to generate electronic loyalty reward certificate selection information and providing the loyalty reward certificate selection information and a recipient mobile device identifier to a loyalty management server. Electronic loyalty reward certificate data derived from the loyalty reward certificate selection information and the recipient mobile device identifier is received from the loyalty management server. The method also includes establishing a communications link with a mobile device corresponding to the recipient mobile device identifier and provisioning the electronic loyalty reward certificate data on the mobile device over the communications link via over the air (OTA) communications.

### PRIORITY CLAIM

This application claims the benefit of U.S. Provisional Patent Application No. 61/141,841, filed on Dec. 31, 2008, the disclosure of which is incorporated herein by reference in its entirety.

### TECHNICAL FIELD

The subject matter described herein relates to the redemption of loyalty points and the subsequent delivery of electronic loyalty rewards utilizing a mobile device. More particularly, the subject matter described herein relates to methods, systems, and computer readable media for redeeming and delivering electronic loyalty reward certificates using a mobile device.

### BACKGROUND

Currently, the primary means for acquiring loyalty rewards entails a customer accessing a merchant, a bank, an airline or any other service provider website by logging into a web based customer account. The customer account keeps track of loyalty points, which are may be accumulated when the customer conducts purchase transactions with the merchant. The merchant website may also have the capability of presenting different reward options on the customer's account page, where the various reward options are displayed based on the number of loyalty points accumulated by the customer. The customer may then utilize a user interface (e.g., a mouse or keyboard) to select and obtain the desired reward option by electronically exchanging the requisite number of loyalty points. After the loyalty points are redeemed, the merchant website then update the customer account page with a new loyalty point balance and initiate the process to send the loyalty reward as selected to the customer by mail or courier. In some instances, the loyalty reward may include a gift card, a calling card, coupon, or a prepaid payment card associated with the same merchant. Alternatively, these card rewards may be associated with some other vendor or company. Regardless of the type of reward card selected, the card (e.g., a magnetic stripe gift card) is typically packaged and sent to the consumer via a typical mail delivery service. After receiving the prepaid payment card in the mail, the customer may then take the gift card to the appropriate merchant and use it to make a purchase by presenting the prepaid payment card to a cashier. Notably, the delivery process is a completely manual process, and the gift card is usually embodied as a tangible, physical card, such as a plastic cutout card with a magnetic strip or bar code. As such, the fact that the prepaid payment card is a tangible object that must be physically presented to a cashier may give rise to certain problems. For instance, due to its size, the physical gift card may be readily misplaced, stolen, or even damaged prior to the customer using the gift card at the store.

Accordingly, there exists a need for methods, systems, and computer readable media for redeeming and delivering electronic loyalty reward certificates using a mobile device.

### SUMMARY

Methods, systems, and computer readable media for redeeming and delivering electronic loyalty reward certificates in using a mobile device are disclosed. In one embodiment, the method includes utilizing a loyalty reward certificate selection device to generate electronic loyalty reward certificate selection information and providing the loyalty reward certificate selection information and a mobile device identifier to a loyalty management server. Electronic loyalty reward certificate data derived from the loyalty reward certificate selection information and the mobile device identifier is received from the loyalty management server. The method also includes establishing a communications link with a mobile device corresponding to the mobile device identifier and provisioning the electronic loyalty reward certificate data on the mobile device over the communications link via over the air (OTA) communications.

The subject matter described herein for redeeming and delivering electronic loyalty reward certificates using a mobile device may be implemented using a computer readable medium having stored thereon computer executable instructions that when executed by the processor of a computer perform steps. Exemplary computer readable media suitable for implementing the subject matter described herein includes disk memory devices, programmable logic devices, application specific integrated circuits, and other non-transitory storage media. In one implementation, the computer readable medium may include a memory accessible by a processor. The memory may include instructions executable by the processor for implementing any of the methods for redeeming and delivering electronic loyalty reward certificates using a mobile device described herein. In addition, a computer readable medium that implements the subject matter described herein may be distributed across multiple physical devices and/or computing platforms.

### BRIEF DESCRIPTION OF THE DRAWINGS

The subject matter described herein will now be explained with reference to the accompanying drawings of which:

FIG. 1 is a block diagram of an exemplary system for redeeming and delivering electronic loyalty reward certificates using a mobile device according to an embodiment of the subject matter described herein;

FIG. 2 is a block diagram of an exemplary over the air (OTA) provisioning server used to redeem and deliver loyalty reward certificates according to an embodiment of the subject matter described herein; and

FIG. 3 is a flow chart of an exemplary process for redeeming and delivering electronic loyalty reward certificates using a mobile device according to an embodiment of the subject matter described herein.

### DETAILED DESCRIPTION

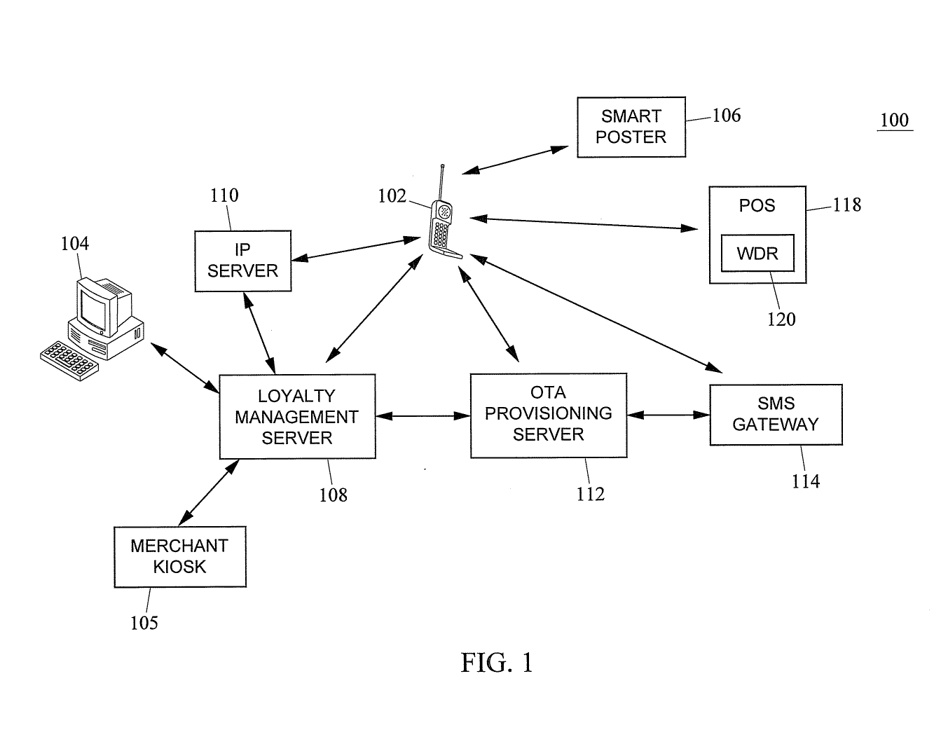

FIG. 1 is a block diagram of an exemplary system 100 for redeeming and delivering electronic loyalty reward certificates in real time using a mobile device according to an embodiment of the subject matter described herein. In one embodiment, system 100 comprises a plurality of components, which may include a mobile device 102, a plurality of selection devices (e.g., a computer 104, a merchant kiosk 105, and a smart poster 106), a loyalty management server 108, a Web server 110, an over the air (OTA) provisioning server 112, an SMS gateway 114, and a point of sale (POS) terminal 118, which includes a wireless device reader 120. Each of mobile device 102 (with and without smart poster 106), computer 104, and kiosk 105 provides a user with the means to select an electronic loyalty reward certificate for delivery to mobile device 102. In one embodiment, mobile device 102 includes a near field communications (NFC) enabled mobile device. For example, the NFC enabled mobile device may comprise a mobile phone with embedded NFC support circuitry/software, which enables a user to wirelessly communicate with a wireless device reader. Also an NFC enabled mobile device may include universal subscriber identification module (USIM)/USIM integrated circuit card (UICC) NFC support circuitry/software to wirelessly communicate with wireless device reader 120.

As indicated above, system 100 may further include loyalty management server 108 and over-the-air (OTA) provisioning server 112. In one embodiment, loyalty management server 108 may comprise a backend server that is associated with a particular merchant, retailer, a bank, an airline, an Internet-based store, or the like (e.g., a “merchant server”). Loyalty management server 108 may be configured to store loyalty reward certificate data which may be displayed on a web site accessible to users. For example, loyalty management server 108 may store the loyalty reward certificate data, (e.g., loyalty point balance) a particular customer accumulates through purchase transactions with the associated merchant.

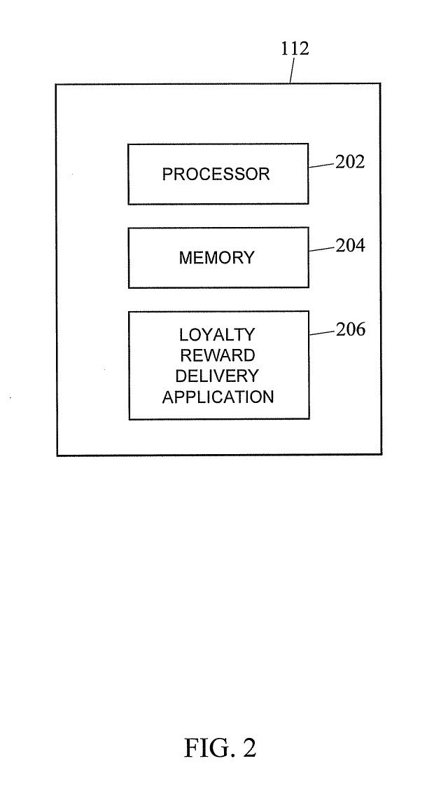

OTA provisioning server 112 may comprise a server that is responsible for receiving loyalty reward selection information from one or more loyalty management servers (e.g., loyalty management server 108) and is responsible for delivering electronic loyalty reward certificates (e.g., an electronic prepaid softcard) to mobile devices per the instructions and information received from a loyalty management server. FIG. 2 is a block diagram of an exemplary over the air (OTA) server used to deliver loyalty reward certificates. For example, FIG. 2 depicts an exemplary OTA server 112, which comprises a processor 202, a memory storage unit 204, and a loyalty reward delivery application 206. In one embodiment, processor 202 may be used to execute computer executable instructions stored on a computer readable medium (e.g., memory unit 204) to control the OTA server 112 to perform one or more of the steps set forth in method 300 (see below). Although FIG. 2 depicts the loyalty reward delivery application 206 as a separate entity from memory unit 204, application 206 may include computer executable instructions that can be stored within memory unit 204 without departing from the scope of the present subject matter.

There are several ways in which a user may redeem loyalty points for an electronic loyalty reward certificate. In one embodiment, a user utilizes a selection device, such as computer 104, which may include a personal computer (e.g., at the user's home), to access a merchant's website. As used herein, the term “merchant” may include a seller, a retailer, a bank, an airline, a loyalty program service provider, manufacturer, or any other entity that is in the business of selling goods or providing services. By using the interface afforded by the merchant website, the user may visit/login to a customer account page on the merchant website. In one embodiment, the customer account page may display a loyalty point balance associated with the user's account (e.g., the loyalty points the user has accumulated through purchase and non-purchase transactions) and prompt the user to make a reward selection. The reward selection may be made from a list of coupons (product or general) or a list of promotions that is presented by the web site. The reward selection may also include a gift card, a prepaid payment card, a post payment credit certificate, a calling card, or an ePurse option in which the user may exchange loyalty points for. Notably, each of the aforementioned loyalty reward selections may be downloaded over the air or through any other IP network as an electronic softcard or certificate to the user's mobile device or another mobile device designated by the user. A receiver is then able to use the redeemed softcard or certificate value received on the mobile device to make purchases at any virtual or physical merchant or service provider. In one embodiment, the user makes a reward selection (i.e., loyalty reward certificate selection information provided to server 108), provides the phone number of mobile device 102, and submits a download request for the selected reward option.

In an alternate embodiment, a user may initiate a loyalty point redemption process by using a wallet client in mobile device 102. A wallet client application may comprise a software application (e.g., a midlet or smart card web server applications) that manages multiple softcards stored on a mobile device, such as credit cards, debit cards, electronic loyalty cards, electronic loyalty reward certificates, electronic coupons, electronic tickets, and the like. The wallet client may also be configured to ensure end-to-end protection of softcard data with its interface for OTA provisioning as well as its management of the mobile device's secure element (not shown). The secure element may include any type of hardware and/or software structure that utilizes encryption or some other means for securing sensitive data within a mobile device.

In one embodiment, the user opens the wallet client and subsequently selects a particular electronic loyalty card in the wallet client and selects a “redemption” option provided by the mobile device. The wallet client may then attempt to contact loyalty management server 108 (e.g., via a TCP/IP connection) associated with the selected loyalty card. The electronic loyalty card serves as the user's identification and may be used to select loyalty rewards, equivalent coupons, promotions, gift/prepaid/ePurse cards, and the like (in lieu of conventional loyalty rewards). For example, the wallet client may display the loyalty points balance associated with the user's account and prompt user to make a reward selection. The reward selection (i.e., loyalty reward certificate selection information provided to server 108) may be made from a list of coupons (product or general), promotions, gift cards, calling cards, prepaid payment cards, and a post payment credit certificates displayed by mobile device 102. The wallet client may then be used to send a download request to server 108 for the selected reward option.

In an alternate embodiment, a user may redeem loyalty points for a reward option by using a merchant kiosk. In one embodiment, the user may present the electronic loyalty card (e.g., a loyalty reward softcard) at merchant kiosk 105 installed at a merchant/retailer location. The user subsequently enters his mobile phone number into the kiosk keypad and selects a “redemption” option displayed by kiosk 105. Kiosk 105 may be configured to display the loyalty points balance and prompts the user to make a reward selection. The reward selection (i.e., loyalty reward certificate selection information provided to server 108) may be made from a list of coupons (product or general) or a list of promotions displayed on a screen of kiosk 105. The reward selection may also include a gift card, a prepaid payment card, a calling card, a post payment credit certificate, or an ePurse option in which the user may exchange loyalty points for. Notably, each of the aforementioned selections may be downloaded over the air to mobile device 102. In one embodiment, the wallet client sends the mobile device phone number and a download request for the selected option to server 108.

In yet another embodiment, a user may initiate the redemption process using a smart poster. Generally, a smart poster is embodied as a sign, billboard, or any other form of advertising that incorporates a passive NFC tag (e.g., an RFID tag) from which the user can extract tag data by interfacing an NFC enabled mobile device with the tag. The tag data acquired may be a uniform resource locator (URL), a coupon, a ticket, a promotion (e.g., “scan here to add 50 additional loyalty points associated with FoodMartStore”), a gift card, a prepaid payment card, a post payment credit certificate, or any other type of data (e.g., URL of phone web application on IP server 110, location of smart poster, and merchant data). For example, the user may use a powered NFC enabled mobile device 102 to acquire or “pull” data (e.g., tag data) from a passive tag of a smart poster 106. After interfacing with smart poster 106, mobile device 102 may initiate a midlet that is responsible for transmitting the electronic loyalty reward data (i.e., loyalty reward certificate selection information) to a backend server (e.g., merchant sever 108). Namely, the midlet is able to use the tag data to properly communicate with the proper loyalty management server as well as to request the proper loyalty reward certificate.

In one embodiment, for example, the user may interface (e.g., touch) mobile device 102 with a smart tag on smart poster 106 and obtain smart poster tag data. Mobile device 102 may then open a browser (e.g., a mobile device Internet browser application), which then sends the smart poster data and the mobile device's phone number (i.e., a mobile device identifier) to IP server 110 (which supports a website or phone web application designed for mobile phone viewing) in order to obtain loyalty point or reward information associated with the user. If IP server 110 fails to receive the mobile device phone number along with the smart poster data, server 110 redirects mobile device 102 to a web page that allows the user to manually enter the phone number. After the phone number is received by server 110, IP server 110 contacts loyalty management server 108 (using merchant data from smart poster) and provides the mobile device number. The mobile device number serves as the user's identification and may be used to select loyalty rewards, equivalent coupons, promotions, gift/prepaid/ePurse cards, and the like (e.g., instead of conventional loyalty rewards). In one embodiment, the phone browser may display the loyalty points balance and prompt the user to make a reward selection. The reward selection (i.e., loyalty reward certificate selection information provided to server 108) may be made from a list of coupons (product or general) or a list of promotions displayed on the screen of mobile device 102. The reward selection may also include a gift card, a prepaid payment card, a calling card, a post payment credit certificate, or an ePurse option. Notably, each of the aforementioned selections may be downloaded over the air from the loyalty management server 108 (via OTA server 112) as explained below to mobile device 102. The user ultimately uses the phone browser to make a selection and submits a download request for the selected option to server 108.

Upon receiving the loyalty reward selection data (and mobile device identifier), loyalty management server 108 may be configured to perform a series of operations. In one embodiment, loyalty management server 108 may process the received loyalty reward selection data and mobile device number (i.e., a mobile device identifier) from the user to generate additional data. For example, loyalty management server 108 may generate additional electronic loyalty reward certificate information such as the electronic loyalty reward certificate number, the electronic loyalty reward certificate image, an electronic loyalty reward certificate authorization code, and the electronic loyalty reward certificate validity information in response to receiving the loyalty reward selection data (and recipient phone number). Likewise, loyalty management server 108 may generate personalization information using the certificate selection data and recipient data obtained from the user. In one embodiment, loyalty management server 108 sends the above-mentioned selection and generated data to OTA provisioning server 112 via a request message. For example, the request message may be embodied as a message requesting that OTA provisioning server 112 issue a valid electronic loyalty reward certificate to the recipient mobile device number provided.

As mentioned above, the electronic loyalty reward certificate may be an electronic gift card, an electronic prepaid payment card, an electronic calling card, an ePurse card, a post payment credit certificate, or the like. For example, OTA provisioning server 112 may deliver the electronic loyalty reward certificate (regardless of type) as a softcard to NFC enabled mobile device 102. In one embodiment, OTA provisioning server 112 sends a control SMS message (or a WAP push or system SMS message) via SMS gateway 114 to NFC enabled mobile device 102 using the mobile phone number provided by loyalty management server 108 (which originally received the phone number from mobile device 102). In response, NFC enabled mobile device 102 may read the SMS control message content, which triggers the midlet application (e.g., wallet client application) that initiates a downloading process to receive an electronic loyalty reward certificate from OTA provisioning server 112. In one embodiment, the download process may be initiated through a control SMS message or via TCP/IP. NFC enabled mobile device 102 (e.g., via wallet client) may then reply to OTA provisioning server 112 with an acknowledgement message.

In response to the acknowledgement message, OTA provisioning server 112 may establish a secure connection using, for example, an hypertext transfer protocol (http), hypertext transfer protocol secure (https) protocol, a transmission control protocol (TCP)/Internet protocol (IP), a short message service point to point protocol (SMS PP), or CAT_TP protocol with NFC enabled mobile device 102. Notably, OTA provisioning server 112 may use the connection to provide certificate personalization data (e.g., similar to Track 1 and Track 2 data), electronic loyalty reward certificate data, and branding or issuer marketing data (e.g., branding image, customer support number, network supported, and the like) to mobile device 102. In one embodiment, the electronic loyalty reward certificate data provisioned on mobile device 102 may be branded with a brand image. Similarly, the electronic loyalty reward certificate data may also be coupled with personalized marketing, such a personal message to the recipient or a thanking message.

In one embodiment, personalization data includes data that is unique to the recipient of the electronic loyalty reward certificate and is typically delivered to a mobile device via secured communications. Similarly, the electronic loyalty reward certificate data and personalization data may also be stored on a secure element validated within mobile device 102. For example, electronic loyalty reward certificates preloaded with a value that exceeds a certain threshold (e.g., $100 gift card) may be stored in the secure element over a secure connection using personalization data (e.g., a password). In an alternate embodiment, the present subject matter may forego establishing a secure connection and storing the certificate data in the secure element. In yet another embodiment, an electronic loyalty reward certificate may be transmitted over an unsecured connection and stored in the mobile device's general memory.

In an alternate embodiment, the delivery process may be directly initiated by a user that utilizes the mobile device's wallet client. For example, the wallet client may be used to transmit a request to OTA provisioning server 112 to start the download of a selected electronic loyalty reward certificate from OTA provisioning server 112 in the same manner described above.

Once the download process is completed, the wallet client may display the electronic loyalty reward certificate as a softcard (which visually represents the electronic loyalty reward certificate data and/or personalization data contained in the secure element or general memory). After the softcard is stored in NFC enabled mobile device 102, the user may decide to use the electronic loyalty reward certificate at an appropriate retail store or the like. For example, after deciding to purchase a particular good at a store, the user brings the merchandise to the checkout register station and is prompted by the cashier to provide a method of payment. The user may then use mobile device 102 to select the loyalty reward softcard to be used in the payment transaction. For example, the user may interface mobile device 102 with wireless device reader 120 via NFC communication. Thus, electronic loyalty reward certificate data (and/or personalization data associated with the loyalty reward softcard, if necessary) is then transferred to point of sale terminal 118. Namely, the transfer of this information facilitates an efficient transfer of loyalty reward data for payment. In one embodiment, the loyalty reward softcard transaction may also be coupled with an NFC electronic prepaid softcard transaction. In this particular scenario, the payment transaction would proceed normally if the combination of electronic funds (i.e., prepaid softcard and electronic loyalty reward softcard) is sufficient to cover the selected good(s). Otherwise the customer may be prompted to provide additional payment for the outstanding balance.

Devices with wireless communications capabilities may also be capable of data communications with remote entities. For example, devices with wireless communications capabilities may implement HTTP over TCP/IP over-the-air (OTA) interface for communicating with remote entities. The OTA interface protocol used by a device with wireless communications capabilities may vary with the device. Examples of OTA interface protocols that may be used include GSM, GPRS, CDMA, Bluetooth, and the like.

Specifically, NFC involves communication via magnetic field induction, where two loop antennas are located within each other's near field, which effectively forms an air-core transformer. For example, NFC enabled mobile device 102 may communicate with wireless device reader 120 via the inductive coupling, of the reader's antenna to the mobile device's antenna. Wireless device reader 120 modulates the loading on its loop antenna in order to amplitude-modulate a radio frequency (RF) field/electromagnetic field. The modulations in the field are received and detected by the NFC enabled mobile device's antenna, thereby communicating information. In order to communicate, a transceiver module on the wireless device reader 120 may transmit a command signal to the mobile device 102 via the electromagnetic field (or some other energy field) powered by wireless device reader 120. For example, by oscillating the electromagnetic field on and off very quickly, the wireless device reader 120 (via the transceiver module) is able to send a command as a string of data to mobile device 102. Similarly, by drawing power from the electromagnetic field or using its own power source, mobile device 102 is able to send a response to wireless device reader 120 by creating a short circuit on its own antenna. The short circuit produces a larger load on the reader's antenna, which is promptly detected as a communication from mobile device 102. An example of a near-field wireless communications standard commonly used by NFC enabled mobile devices and wireless smart cards is ISO 14443.

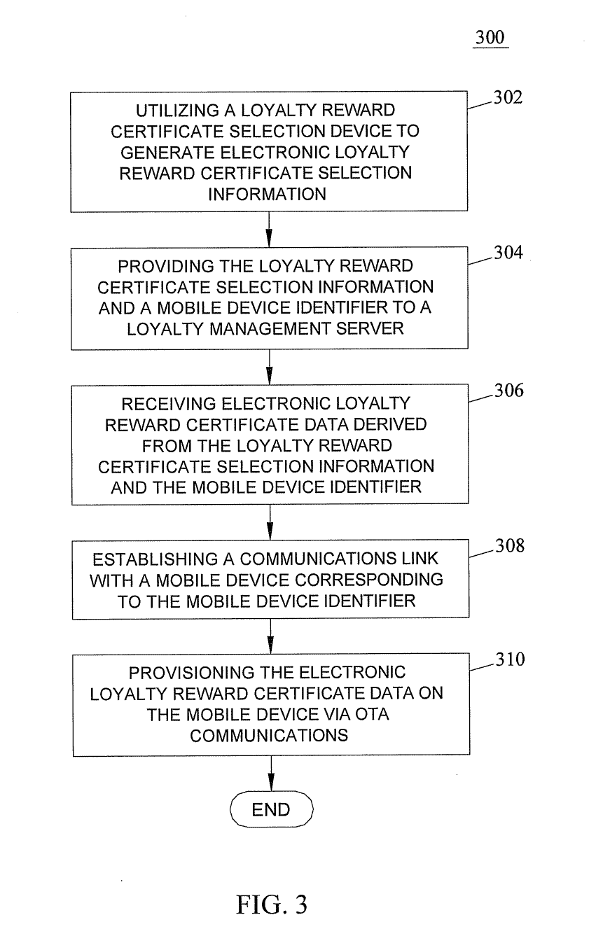

To better illustrate the redeeming and delivering of electronic loyalty reward certificates in real time using the components depicted in FIG. 1, FIG. 3 is a flow diagram provided to depict an exemplary process. Specifically, FIG. 3 is a flow chart of an exemplary method 300 for selecting and provisioning an electronic certificate according to an embodiment of the subject matter described herein. Although FIG. 3 is directed to the redemption and delivery of a gift card, method 300 may be used to select any electronic value loyalty certificate (e.g., a calling card) without departing from the scope of the present subject matter.

In block 302, a loyalty reward certificate selection device is utilized to generate electronic loyalty reward certificate selection information. In one embodiment, a user uses mobile device 102 to log into a customer account via a merchant's website. For example, the user may use a mobile device's web browser to access the merchant's website and make a reward selection based on the amount of loyalty points accrued. In one embodiment, the user utilizes the website interface to select a specific type of electronic prepaid payment card (e.g., electronic loyalty reward certificate selection information). In an alternate embodiment, the user may utilize a personal computer or a kiosk computer station instead of the mobile device to gain access to the customer account on the merchant's website.

In block 304, the loyalty reward certificate selection information and a mobile device identifier (i.e., recipient information) is provided to a loyalty management server. In one embodiment, the user's loyalty redemption request, which comprises the loyalty reward selection and the user's mobile phone number, is transmitted to loyalty management server 108. For example, the user's loyalty reward selection (e.g., electronic loyalty reward certificate selection information) and recipient data are received by loyalty management server 108. In one embodiment, after finalizing the loyalty reward selection and confirming the recipient data, the user electronically submits (e.g., hits a “submit” button on the user interface) the information to loyalty management server 108.

In block 306, electronic loyalty reward certificate data derived from the loyalty reward certificate selection information and the mobile device identifier is received from the loyalty management server. In one embodiment, the website transmits the mobile device identifier and the loyalty reward selection information to loyalty management server 108, which processes the received data and generates electronic loyalty reward certificate data.

In block 308, a communications link with a mobile device corresponding to the mobile device identifier is established. In one embodiment, OTA provisioning server 112 receives a provisioning request message from loyalty management server 108 to issue an electronic loyalty reward softcard to a recipient that is associated with a specific mobile phone number (i.e., the mobile phone number provided by the user in block 304). In response, a control short message may be generated by OTA provisioning server 112 that is sent to mobile device 102 via SMS gateway 114. Namely, the control SMS may comprise a control (binary) short message service (SMS) message that serves to instruct the recipient's NFC enabled mobile device to activate a wallet client application

In block 310, the electronic loyalty reward certificate data is provisioned on the mobile device over the communications link via over the air (OTA) communications. In one embodiment, mobile device 102 receives the control SMS and responds by sending an acknowledgement message to OTA provisioning server 112. OTA provisioning server 112 may then establish a connection (e.g., a secure connection using, an http, https, TCP, SMS PP, or CAT_TP protocol) with mobile device 102 in order to download the electronic loyalty reward card. In one embodiment, branding images and marketing data may be provisioned to mobile device 102 along with the electronic loyalty reward certificate data.

In one embodiment, the entire method 300 is performed in real time, such that the conversion of loyalty points into a redeemable value (i.e., selecting a loyalty reward option to provisioning of the loyalty reward to a mobile device) is performed without delay. In an alternate embodiment, method 300 may be performed in non-real time such that a delay of any significant time (e.g., hours or days) is permissible.

It will be understood that various details of the subject matter described herein may be changed without departing from the scope of the subject matter described herein. Furthermore, the foregoing description is for the purpose of illustration only, and not for the purpose of limitation.

1. A method for providing an electronic loyalty reward certificate to a mobile device, the method comprising:
utilizing a loyalty reward certificate selection device to generate electronic loyalty reward certificate selection information;
providing the loyalty reward certificate selection information and a recipient mobile device identifier to a loyalty management server;
receiving, from the loyalty management server, electronic loyalty reward certificate data derived from the loyalty reward certificate selection information and the recipient mobile device identifier;
establishing a communications link with a mobile device corresponding to the recipient mobile device identifier; and
provisioning the electronic loyalty reward certificate data on the mobile device over the communications link via over the air (OTA) communications.

2. The method of claim 1 wherein the mobile device includes a near field communications (NFC) enabled mobile device.

3. The method of claim 1 wherein the loyalty reward certificate selection device comprises at least one of a mobile device, a personal computer, or a merchant kiosk station.

4. The method of claim 1 wherein the recipient mobile device identifier includes a mobile device phone number.

5. The method of claim 1 wherein utilizing a loyalty reward certificate selection device includes:
interfacing the mobile device to a smart poster;
using a web browser of the mobile device to access a website associated with the smart poster; and
selecting a loyalty reward option presented by the website using the web browser to generate the electronic loyalty reward certificate selection information.

6. The method of claim 1 wherein utilizing a loyalty reward certificate selection device includes:
using a web browser at a merchant kiosk station or personal computer to access a website that presents loyalty reward options; and
selecting at least one of the loyalty reward options using the web browser to generate the electronic loyalty reward certificate selection information.

7. The method of claim 1 wherein establishing a communications link includes establishing a secure connection between the mobile device and an OTA provisioning server using at least one of a hypertext transfer protocol, an hypertext transfer protocol secure protocol, a transmission control protocol/Internet protocol, a short message service point to point protocol, or a CAT_TP protocol.

8. The method of claim 1 wherein provisioning the electronic loyalty reward certificate data includes sending the electronic loyalty reward certificate data to the mobile device, and converting the electronic loyalty reward certificate data to an electronic loyalty reward softcard.

9. The method of claim 1 includes receiving a request from the loyalty management server to provide the electronic loyalty reward certificate data to the mobile device associated with the receiving mobile device identifier.

10. The method of claim 1 wherein establishing a communications link includes sending a control SMS message to the mobile device, and receiving an acknowledgement message responding to the control SMS message from the mobile device.

11. The method of claim 1 wherein provisioning the electronic loyalty reward certificate data includes provisioning the electronic loyalty reward certificate data with branding and issuer marketing data.

12. The method of claim 11 wherein the branding and issuer marketing data includes a brand image and a personalized marketing message.

13. The method of claim 1 wherein the utilizing, providing, receiving, establishing, and provisioning elements are performed in real time.

14. A computer readable medium having stored thereon computer executable instructions that when executed by a processor of a computer control the computer to perform steps comprising:
utilizing a loyalty reward certificate selection device to generate electronic loyalty reward certificate selection information;
providing the loyalty reward certificate selection information and a recipient mobile device identifier to a loyalty management server;
receiving, from the loyalty management server, electronic loyalty reward certificate data derived from the loyalty reward certificate selection information and the recipient mobile device identifier;
establishing a communications link with a mobile device corresponding to the recipient mobile device identifier; and
provisioning the electronic loyalty reward certificate data on the mobile device over the communications link via over the air (OTA) communications.

15. The computer readable medium of claim 14 wherein the mobile device includes a near field communications (NFC) enabled mobile device.

16. The computer readable medium of claim 14 wherein the loyalty reward certificate selection device comprises at least one of a mobile device, a personal computer, or a merchant kiosk station.

17. The computer readable medium of claim 14 wherein the recipient mobile device identifier includes a mobile device phone number.

18. The computer readable medium of claim 14 wherein utilizing a loyalty reward certificate selection device includes:
interfacing the mobile device to a smart poster;
using a web browser of the mobile device to access a website associated with the smart poster; and
selecting a loyalty reward option presented by the website using the web browser to generate the electronic loyalty reward certificate selection information.

19. The computer readable medium of claim 14 wherein utilizing a loyalty reward certificate selection device includes:
using a web browser at a merchant kiosk station or personal computer to access a website that presents loyalty reward options; and
selecting at least one of the loyalty reward options using the web browser to generate the electronic loyalty reward certificate selection information.

20. The computer readable medium of claim 14 wherein establishing a communications link includes establishing a secure connection between the mobile device and an OTA provisioning server using at least one of a hypertext transfer protocol, an hypertext transfer protocol secure protocol, a transmission control protocol/Internet protocol, a short message service point to point protocol, or a CAT_TP protocol.

21. The computer readable medium of claim 14 wherein provisioning the electronic loyalty reward certificate data includes sending the electronic loyalty reward certificate data to the mobile device, and converting the electronic loyalty reward certificate data to an electronic loyalty reward softcard.

22. The computer readable medium of claim 14 includes receiving a request from the loyalty management server to provide the electronic loyalty reward certificate data to the mobile device associated with the receiving mobile device identifier.

23. The computer readable medium of claim 14 wherein establishing a communications link includes sending a control SMS message to the mobile device, and receiving an acknowledgement message responding to the control SMS message from the mobile device.

24. The computer readable medium of claim 14 wherein provisioning the electronic loyalty reward certificate data includes provisioning the electronic loyalty reward certificate data with branding and issuer marketing data.

25. The computer readable medium of claim 24 wherein the branding and issuer marketing data includes a brand image and a personalized marketing message.

26. The computer readable medium of claim 14 wherein the utilizing, providing, receiving, establishing, and provisioning elements are performed in real time.

27. A system for providing an electronic loyalty reward certificate to a mobile device, comprising:
a loyalty reward selection device for generating electronic loyalty reward certificate selection information;
a loyalty management server for receiving electronic loyalty reward certificate selection information and a recipient mobile device identifier from the loyalty reward selection device, and for deriving electronic loyalty reward certificate data from the loyalty reward certificate selection information and the mobile device identifier; and
an over the air (OTA) provisioning server for receiving, from the loyalty management server, the electronic loyalty reward certificate data, for establishing a communications link with the mobile device corresponding to the recipient mobile device identifier, and provisioning the electronic loyalty reward certificate data on the mobile device over the communications link.

28. The system of claim 27 wherein the mobile device includes a near field communications (NFC) enabled mobile device.

29. The system of claim 27 wherein the loyalty reward certificate selection device comprises at least one of a mobile device, a personal computer, or a merchant kiosk station.

30. The system of claim 27 wherein the recipient mobile device identifier includes a mobile device phone number.

31. The system of claim 27 wherein the loyalty reward selection device comprises a mobile device and is further configured to interface with the a smart poster, utilize a web browser of the mobile device to access a website associated with the smart poster, and select a loyalty reward option presented by the website using the web browser to generate the electronic loyalty reward certificate selection information.

32. The system of claim 27 wherein the loyalty reward selection device comprises a merchant kiosk station or personal computer and is further configured to utilize a web browser at the merchant kiosk station or personal computer to access a website that presents loyalty reward options, and select at least one of the loyalty reward options using the web browser to generate the electronic loyalty reward certificate selection information.

33. The system of claim 27 wherein the OTA provisioning server is further configured to establish a secure connection between the mobile device and the OTA provisioning server using at least one of a hypertext transfer protocol, an hypertext transfer protocol secure protocol, a transmission control protocol/Internet protocol, a short message service point to point protocol, or a CAT_TP protocol.

34. The system of claim 27 wherein the OTA provisioning server is further configured to send the electronic loyalty reward certificate data to the mobile device, and converting the electronic loyalty reward certificate data to an electronic loyalty reward softcard.

35. The system of claim 27 wherein the OTA provisioning server is further configured to receive a request from the loyalty management server to transmit the electronic loyalty reward certificate data to the mobile device associated with the receiving mobile device identifier.

36. The system of claim 27 wherein the OTA provisioning server is further configured to send a control SMS message to the mobile device, and receive an acknowledgement message responding to the control SMS message from the mobile device.

37. The system of claim 27 wherein the OTA provisioning server is further configured to send the electronic loyalty reward certificate data with branding and issuer marketing data to the mobile device.

38. The system of claim 37 wherein the branding and issuer marketing data includes a brand image and a personalized marketing message.
